(19) United States
(12) Patent Application Publication
(10) Pub. No.: US 2003/0127176 A1
(43) Pub. Date: Jul. 10, 2003

(54) Optical device, optical isolator and method for producing the same

(75) Inventors: Hiroki Yoshikawa, Gunma (JP); Shigeru Konishi, Gunma (JP); Masatoshi Ishii, Gunma (JP); Toru Shirasaki, Gunma (JP)

Correspondence Address: HOGAN & HARTSON L.L.P., 500 S. GRAND AVENUE, SUITE 1900, LOS ANGELES, CA, 90071-2611, US

(73) Assignee: SHIN-ETSU CHEMICAL CO., LTD.

(21) Appl. No.: 10/242,047

(22) Filed: Sep. 12, 2002

(30) Foreign Application Priority Data
Sep. 12, 2001 (JP) 2001-277237
Sep. 12, 2001 (JP) 2001-277302

(51) Int. Cl. G02B 1/00; G02C 7/00; B32B 17/00; C03C 27/00

(52) U.S. Cl. 156/99

(57) ABSTRACT

The present invention provides An optical device, which is formed by bonding two polarizers to both surfaces of a magnetic garnet crystal directly or through a transparent optical material without using an adhesive and which functions when light is transmitted through its bonded surface, wherein the optical device is formed with a sufficient bonding strength on either condition that at least one or more of each linear expansion coefficient and thickness of the magnetic garnet crystal, the transparent optical material and the polarizer is controlled; or that a bonded body, which is formed by bonding them directly or through the transparent optical material without using an adhesive, is fixed on a base. Thus, there is provided a small size, highly reliable, and, low cost optical devise formed by bonding each optical element without using an adhesive.

### BACKGROUND OF THE INVENTION

1. Field of the Invention

The present invention relates to an optical device of which optical elements are bonded without using an adhesive, and a method for producing an optical device. Moreover, the present invention relates to an optical isolator, which is used as an optical component and which can transmit light to a forward direction but not transmit light to a backward direction, and a method for producing the same.

2. Related Art

Recently, high integration of optical communication system has been made according to increasing the number of wavelength in WDM (Wavelength Division Multiplex). As the result, the demand for miniaturizing optical devices used therein has been increased. The most optical devices are composed of combinations of bonded bodies formed by bonding optical elements such as a Faraday rotator and polarizers to a fixing member. However according to this method, a fixing member hinders the miniaturization of optical devices. Accordingly, it has been, considered a method such that a fixing member is omitted and optical elements are bonded to each other.

In the case of miniaturizing optical devises, it is effective to bond optical elements to each other on each light transmissive surface. The easiest method for bonding each optical element is to bond them by using an organic adhesive. For example, Japanese Patent Laid-open Publication No. 6-75189 discloses an optical isolator, which is unified by adhering two polarizers and a Faraday rotator by use of an optical adhesive or resin. However, use of an organic adhesive has several faults such that an organic adhesive generates outgas, which has bad influences upon a laser diode and so on, it has a weakness for irradiation of high energy laser and exposure under high temperature and high humidity atmosphere, and it lacks reliability of devices.

Accordingly, a method for bonding optical elements without an organic adhesive has been desired and has been considered. For example, as one of them, there is a method such that each optical element is bonded by using a low-melting glass or solder as an inorganic bonding material. A low-melting glass is a glass for bonding of which major components are low-melting materials such as PbO, B₂O₃ or TeO₂. However, it requires that bonding should be performed under the temperature higher than a softening point of glass. Therefore, in the case that bonding is performed by use of a low-melting glass, there is a problem such that when a low-melting glass is softened, an antireflection film formed on an optical element reacts with a low-melting glass, so that its antireflection function is spoiled. (See Japanese Patent Laid-open application No. 2000-56265.) On account of this, it seems very difficult to put the optical elements obtained by using a low-melting glass for bonding each light transmissive surface to practical use.

On the other hand, in the case of using solder, since solder has no transparency, it can not be disposed directly an each light transmissive surface. Therefore, such a bonding method that each outer frame of light transmissive surfaces is selectively metalized to exist solder only on the metalized surface is employed. Such a bonding method suffers from a problem that a complicate metalizing process is required, and therefore, decrease in yield and increase in cost can not be avoided.

Also, a method that each optical element is directly bonded without using an adhesive has been attempted. (See Japanese Patent Laid-Open Application No. 7-220923 and Japanese Patent Laid-Open Application No. 2000-56265.) According to these methods, after hydrophilic treatment is performed on each surface of optical elements, each hydrophilic-treated surface is bonded. In the semiconductor field, those methods have been put to practical use in a production process of SOI (Silicon on Insulator) wafer. However, in the case of applying this method to an optical device, it suffers from problems as follows and therefore it is a difficult situation to put this method to practical use.

This direct bonding method considerably depends on each shape and physical property of components to be bonded. For example, in regard to a warp, a warp is desirably controlled to be several hundred meters or more in curvature radius. Also, in regard to surface roughness of components to be bonded, it can be said that a roughness is desirably controlled as Ra=0.3 nm or less. Moreover, this method also depends on the difference of linear expansion coefficient between components to be bonded. In the case of bonding each semiconductor silicon wafer, these conditions can be relatively easily satisfied.

However, there are few optical elements, which satisfy the above conditions. For example, since iron garnet crystal or the like, which is one of optical elements used generally in optical devices, has a stress distribution in the direction of thickness, it is often accompanied by a large warp. Accordingly, in the case of directly bonding such optical elements to each other, delamination is easily generated on each bonded surface, and therefore adhesiveness and durability of the bonded surface become low.

Moreover, it in often the case that each linear expansion coefficient of these optical elements varies drastically according to each material, and therefore great differences occur in each linear expansion coefficient between components to be bonded. In such a case that materials having a different linear expansion coefficient are directly bonded, particularly bonded by subjecting them to a heat treatment to improve bonding strength between components to be bonded, delamination is easily generated due to generation of thermal stress between different kind materials. Further, there is a problem that since optical strain is easily generated by concentrating thermal stress on a bonded portion, optical characteristics such as an extinction ratio is reduced. Therefore, it is a very difficult situation to apply a direct bonding technique to an optical device as it is.

As described above, in conventional techniques, it is a very difficult situation that optical elements are bonded without using an organic adhesive so that a highly reliable optical device is not easily produced with low cost.

Also, one of the most useful optical devices is an optical isolator. For example, in optical communication, light emitted from a semiconductor laser is transmitted by projecting it in an end face of an optical fiber passing through a lens. However, a part of light is reflected on surfaces of a lens or end face of the optical fiber and returned to the semiconductor laser to become a noise. This noise has a damaging effect such that the light oscillation mode of a semiconductor laser becomes unstable. Therefore, an optical isolator is used for eliminating such returned light.

An optical isolator is composed of optical elements such as two polarizers and a Faraday rotator. For example, Japanese Patent Laid-open application No. 6-75189 discloses an optical isolator, which is unified by adhering two polarizers and a Faraday rotator by use of an optical adhesive or resin. However, the optical isolator adhered by use of an adhesive or the like suffers from problems that it has low moisture resistance and low heat resistance, and since it generates outgas, light axis of the optical isolator deviates from the right direction and other components in a light source module are adversely affected.

As a result, an optical isolator without using an adhesive or resin is used for a light source module, which takes much account of reliability. Generally, this isolator has a structure such that a cylindrical permanent magnet is disposed in a metal housing and two polarizers and a Faraday rotator are fixed therein by solder or low-melting glass. Such a structure makes an optical isolator large by nature.

In order to solve simultaneously such harmful results due to use of an adhesive or resin and the problem of miniaturization of an isolator, for example, as disclosed in Japanese Patent Laid-open applications No. 10-227996 and No. 2001-91899, it is suggested a structure such that each polarizer and a Faraday rotator are cut into quadrilateral respectively, and they are disposed on a base. Also, it is described that this optical isolator is assembled by fixing on the base using solder or low-melting glass without using an adhesive or resin. According to this method, the isolator can be minimized at a certain degree without using an adhesive.

In an optimal isolator, each polarizing direction of a polarizer and an analyzer requires 45 degrees on inserting a Faraday rotator between them. If the angle is not in the right degree, a performance for shielding light of reverse direction (an extinction ratio) is reduced. Therefore, as for the aforementioned optical isolator formed by adhering two polarizers and a Faraday rotator by use of an adhesive, in the case of laminating each optical element, the step of adjusting a relative angle of each component at a certain angle while irradiating a laser thereon is provided. As described above, the maximum capacity as an optical isolator can be educed through the angle adjustment step.

However, according to the method disclosed in the aforementioned Japanese Patent Laid-open applications No. 10-227996 and No. 2001-91899, as shown FIG. 9, an optical isolator 620 is formed by individually fixing a polarizer 614, a Faraday rotator 613, an other polarizer 621 and permanent magnets 618 on a flat plate 619 without an angle adjustment step as aforementioned. Therefore, the angle of 45 degrees between the polarizer and the other polarizer depends on cutting accuracy when each polarizer is cut into a rectangular shape, particularly a square shape. As the result, it suffers from a problem that the angle is easily deviated and an extinction ratio of the optical isolator is reduced.

Also, with a recent further miniaturization of a light source module, particularly, there is a strong demand that a thickness in a light transmission direction of an optical isolator (optical path) is reduced. However, since two polarizers and a Faraday rotator are fixed individually on a base, an air layer is provided among each optical element, and therefore there is a disadvantage that an optical path is lengthened by the air layer.

Also, since two polarizers and a Faraday rotator are fixed individually on a base by use of only one side face corresponding to its thickness, they do not have an enough area to be fixed. In particular, as for a polarizer, which is made of a thin plate, a sufficient fixing strength can not be obtained. Therefore, there is a case that sufficient performance concerning impact resistance and vibration proof may not be secured.

### SUMMARY OF THE INVENTION

Therefore, the present invention was accomplished in view of the aforementioned problems, and the first object of the present invention is to provide a small size and highly reliable optical device with low cost formed by bonding each optical element without using an adhesive. And the second object of the present invention is to provide a miniaturizable, easy to assemble and highly reliable optical isolator formed by firmly bonding each optical element without using an adhesive and having a good insertion loss and extinction ratio and a method for producing the same.

In order to accomplish the above-mentioned first and second objects, the present invention provides an optical device, which is formed by bonding two polarizers to both surfaces of a magnetic garnet crystal directly or through a transparent optical material without using an adhesive and which functions when light is transmitted through its bonded surface, wherein the optical device is formed with a sufficient bonding strength on either condition that

at least one or more of each linear expansion coefficient and thickness of the magnetic garnet crystal, the transparent optical material and the polarizer is controlled;

or that a bonded body, which is formed by bonding them directly or through the transparent optical material without using an adhesive, is fixed on a base.

As described above, if an optical device has the above-described features, the optical device can be formed by bonding each optical element with a sufficient bonding strength without using an adhesive. Also, since an adhesive is not used in the optical device, generation of outgas and degradation of a bonded surface due to high temperature and high humidity atmosphere can be prevented. Therefore, a small size and highly reliable optical device having practical optical characteristics can be provided with low cost. Moreover, if an optical device has the above-described features, a miniaturizable, easy to assembles and highly reliable optical isolator having a good insertion loss and an extinction ratio can be formed.

Also, the present invention provides a method for producing an optical device, which is formed by bonding two polarizers to both surfaces of a magnetic garnet crystal directly or through a transparent optical material without using an adhesive, wherein the formation of the optical device with a sufficient bonding strength is performed

by controlling at least one or more of each linear expansion coefficient and thickness of the magnetic garnet crystal, the transparent optical material and the polarizer;

or by forming a bonded body by bonding them directly or through the transparent optical material without using an adhesive, and then fixing the bonded body on a base.

As described above, according to the method for producing an optical device having the above-described features, each optical element can be bonded with a sufficient bonding strength without using an adhesive. Also, since an adhesive is not used in the optical device, generation of outgas and degradation of a bonded surface due to high temperature and high humidity atmosphere can be prevented. Therefore, a small size and highly reliable optical device having excellent optical characteristics can be produced with low cost.

Further, in order to accomplish the first object, according to the first aspect of the present invention, there is provided an optical device, which is formed by bonding two polarizers to both surfaces of a magnetic garnet crystal through transparent optical materials without using an adhesive and which functions when light is transmitted through its bonded surface, wherein a linear expansion coefficient of the transparent optical material α2 (/° C.) takes a value between a linear expansion coefficient of the magnetic garnet crystal α1 (/° C.) and a linear expansion coefficient of the polarizer α3 (/° C.), a thickness of each transparent optical material t2 (mm) is t2≧0.02 mm, and a thickness of each polarizer t3 (mm) is 0.02 mm≦t3≦0.3 mm.

As described above, since the optical device has the features that the linear expansion coefficient of the transparent optical material α2 takes a value between the linear expansion coefficient of the magnetic garnet crystal α1 and the linear expansion coefficient of the polarizer α3, a thickness of each transparent optical material t2 is t2≧0.02 mm, and a thickness of each polarizer t3 is 0.02 mm≦t3≦0.3 mm, delamination of each optical element can be prevented in a heat treatment process while bonding, so that a sufficient bonding strength can be obtained. Also, thermal stress generated between the magnetic garnet crystal and the polarizer can be reduced, so that degradation of optical characteristics due to optical strain originated from thermal stress can be suppressed. Further, an organic adhesive is not used therein, so that generation of outgas and degradation of a bonded surface due to high temperature and high humidity atmosphere can be prevented. Therefore, a small size and highly reliable optical device having practical optical characteristics can be provided with low cost.

On this occasion, a metal oxide film is preferably formed on a side facing the transparent optical material of the magnetic garnet crystal, and the metal oxide film formed on the magnetic garnet crystal is preferably composed of one kind or two or more kinds of metal oxide films selected from Al₂O₃, TiO₂ and SiO₂, and the metal oxide film is laminated in single-layer or multilayer.

As described above, the metal oxide film is formed on a side facing the transparent optical material of the magnetic garnet crystal, so that it acts as an antireflection film and each optical element can be bonded more firmly. Also, the metal oxide is composed of one kind or two or more kinds of metal oxide films selected from Al₂O₃, TiO₂ and SiO₂, and which is laminated in single-layer or multilayer, so that it has the excellent effect as an antireflection film, and its bonding strength can be improved. Accordingly, a high performance and highly reliable optical device can be formed.

Also, on this occasion, the magnetic garnet crystal is preferably a bismuth-substituted iron garnet crystal, and the polarizer is preferably made of a polarizing glass.

As described above, since the magnetic garnet crystal is a bismuth-substituted iron garnet crystal having an excellent Faraday rotation ability, it is realizable to obtain a Faraday rotation angle of 45° on its thickness of about 0.5 mm, so that it is effective to minimize an optical devise. Also, as described above, one feature of the present invention is that a bonding strength and optical characteristics can be improved by properly setting a thickness of the polarizer, and accordingly a polarizer of which optical characteristics have little dependence on its thickness is preferably used. Therefore, since a polarizer is a polarizing glass of which optical characteristics have little dependence on its thickness, a thickness of the polarizer can be set properly without degradation of its optical characteristics. As for the polarizing glass, a glass to be dispersing metal particles of silver, copper and the like in a commonly used glass matrix such as a borosilicate glass can be used.

Also, the optical device is preferably an optical isolator formed by bonding each polarizer to both sides of the magnetic garnet crystal through the transparent optical material.

An optical isolator is one of the most useful optical devices and it is the essential device for optical communication. As described above, the optical device of the present invention is an optical isolator, so that the optical device, which enables to respond recent high demands of miniaturization of an optical isolator and an organic adhesive free optical device, can be provided.

Next, a method for producing an optical device according to the present invention is a method for producing an optical device by bonding two polarizers to both surfaces of a magnetic garnet crystal through transparent optical materials without using an adhesive, wherein the bonding is performed by using the transparent optical material having a linear expansion coefficient α2 (/° C.), which takes a value between a linear expansion coefficient of the magnetic garnet crystal α1 (/° C.) and a linear expansion coefficient of the polarizer α3 (/° C.), and having a thickness t2 (mm) of t2≧0.02 mm, and each polarizer having a thickness t3 (mm) of 0.02 mm≦t3≦0.3 mm.

As described above, the optical device is formed by using the transparent optical material having a linear expansion coefficient α2 (/° C.), which takes a value between a linear expansion coefficient of the magnetic garnet crystal α1 (/° C.) and a linear expansion coefficient of the polarizer α3 (/° C.), and having a thickness t2 (mm) of t2≧0.02 mm, and each polarizer having a thickness of t3 (mm) of 0.02 mm≦t3≦0.3 mm, so that these optical elements can be bonded with a sufficient bonding strength without using an adhesive, and degradation of optical characteristics due to an optical strain can be suppressed. Therefore, a highly reliable optical device having excellent optical characteristics can be produced with low cost.

On this occasion, it is preferable that a bonding between the magnetic garnet crystal and the transparent optical material and/or a bonding between the transparent optical material and the polarizer art performed by subjecting each bonded surface to polishing, cleaning, hydrophilic treatment and drying process; laminating each bonded surface directly or through water; and then subjecting them to a heat treatment.

As described above, since the bonded surfaces of the magnetic garnet crystal and the transparent optical material and/or the bonded surface of the transparent optical material and the polarizer is subjected to polishing, cleaning, hydrophilic treatment and drying process, and then each bonded surface is bonded directly or through water followed by subjecting them to a heat treatment, interaction between chemical species, which constitutes the magnetic garnet crystal, and chemical species, which constitutes the transparent optical material, and/or interaction between chemical species, which constitutes the transparent optical material, and chemical species, which constitutes the polarizer, can work effectively, so that a sufficient bonding strength can be obtained. And therefore, delamination of each bonded surface can be prevented.

Further, on this occasion, it is preferable that after a metal oxide film is formed on a side facing the transparent optical material of the magnetic garnet, crystal, the magnetic garnet crystal is bonded to the transparent optical material.

As described above, since after a metal oxide film is formed on a side facing the transparent optical material of the magnetic garnet crystal, the magnetic garnet crystal is bonded to the transparent optical material, a bonding strength of each optical element can be further improved. Also, since the formed metal oxide film has a function as an antireflection film in the optical device, a highly reliable and high performance optical device can be produced.

Further, it is preferable that a metal oxide film to be formed on the magnetic garnet crystal is composed of one kind or two or more kinds of metal oxide films selected from Al₂O₃, TiO₂ and SiO₂, and the metal oxide film is laminated in single-layer or multilayer.

As described above, a metal oxide film is composed of one kind or two or more kinds of metal oxide films selected from Al₂O₃, TiO₂ and SiO₂, and the metal oxide film is laminated in single-layer or multilayer, so that a function of the metal oxide film as an antireflection film can be further improved and a bonding strength of each optical element can be also improved.

Also, an optical isolator is preferably produced by bonding two polarizers to both sides of the magnetic garnet crystal through the transparent optical materials.

Since the optical isolator is produced as described above, a small size optical isolator having a sufficient bonding strength can be produced without using an adhesive.

In order to accomplish the above-described second object, according to the second aspect of the present invention, there is provided an optical isolator, which is formed by fixing at least two polarizers, a magnetic garnet crystal, and permanent magnets, which put the magnetic garnet crystal in the magnetic field for saturation, on a base, wherein a bonded body is formed by bonding two polarizers to the magnetic garnet crystal directly or through transparent optical materials without using an adhesive, and the bonded body, which functions when light is transmitted through its bonded surface, is fixed on the base.

As described above, since after a bonded body is previously formed by bonding two polarizers to the magnetic garnet crystal directly or through a transparent optical material without using an adhesive, an optical isolator is formed by fixing the bonded body on the base, each angle of the two polarizers can be adjusted when each optical element is bonded, so that a high performance optical isolator can be provided.

Also, since two polarizers and the magnetic garnet crystal are previously bonded without using an adhesive, length of the isolator in the transmission direction of light can be suppressed to a sum of length of each optical element, so that a particularly small size optical isolator can be provided.

Furthermore, since the bonded body formed by bonding two polarizers and the magnetic garnet crystal is fixed on the base, a sufficient fixing strength can be obtained, and highly reliable optical isolator which can be easily assembled and has good insertion loss and a good extinction ratio, can be produced with low cost.

In this case, it is possible that metal oxide films are formed on each bonded surface of the magnetic garnet crystal, and the metal oxide films are composed of one kind or two or more kinds of metal oxide films selected from Al₂O₃, TiO₂ and SiO₂, and the metal oxide films are laminated in single-layer or multilayer.

As described above, since metal oxide films are formed on each bonded surface of the magnetic garnet crystal, and the metal oxide films are composed of one kind or two or more kinds of metal oxide films selected from Al₂O₃, TiO₂ and SiO₂, and which are laminated in single-layer or multilayer, the magnetic garnet crystal can be firmly bonded to two polarizers or two transparent optical materials without using an adhesive and a highly reliable optical isolator having no bad influence on its optical characteristics can be provided. Also there is an advantage such that the metal oxide films function as an antireflection film.

Also, in this case, it is preferable that the magnetic garnet crystal is a bismuth-substituted iron garnet crystal, and the polarizer is polarizing glass.

As described above, for example, in the case that a bonded body is formed by bonding two polarizers made of a polarizing glass to the magnetic garnet crystal made of a bismuth-substituted iron garnet crystal, even if a thickness of each optical element is thinned, each optical element can be functioned sufficiently, so that a small size and high performance optical isolator can be made.

Next, according to the second aspect of the present invention there is provided a method for producing an optical isolator by fixing at least two polarizers, a magnetic garnet crystal and permanent magnets on a base, wherein a bonded body is formed by bonding two polarizers to the magnetic garnet crystal directly or through transparent optical materials without using an adhesive, and then the bonded body and the permanent magnets are fixed on the base by use of a bonding material.

As described above, if a bonded body is formed by bonding two polarizers to the magnetic garnet crystal directly or through transparent optical materials without using an adhesive, and then the bonded body and the permanent magnet are fixed on the base by use of a bonding material, a sufficient bonding strength can be obtained without using an adhesive, so that a small size and highly reliable optical isolator, which can be easily assembled and has good insertion loss and a good extinction ratio, can be produced with low cost.

In this case, it is possible that after metal oxide films are formed on each bonded surface of the magnetic garnet crystal, the bonding is performed, and the metal oxide are composed of one kind or two or more kinds of metal oxide films selected from Al₂O₃, TiO₂ and SiO₂, and the metal oxide films are laminated in single-layer or multilayer.

Also, in this case, it is preferable that cach bonding among two polarizers, the magnetic garnet crystal and the transparent optical materials are performed by subjecting each bonded surface to cleaning, hydrophilic treatment and drying process; laminating each bonded surface directly or through waters and then subjecting them to a heat treatment.

If the bonding is performed as described above, two polarizers, the magnetic garnet crystal and the transparent optical materials can be firmly bonded easily and surely without using an adhesive, so that a highly reliable optical isolator can be produced.

According to the present invention, when the bonded body and the permanent magnets are fixed on the base, at least one of the bonded body and the permanent magnets or the base is heated and the bonded body and the permanent magnets are fixed on the base by use of a bonding material having a melting point.

If the fixing is performed as described above, a bonded body comprising two polarizers, the magnetic garnet crystal, the transparent optical materials and the like and the permanent magnet can be fixed on the base easily and surely, so that a small size and high performance optical isolator, which can be easily assembled and has, good insertion lose and a good extinction ratio, can be produced.

As explained above in detail, the present invention can provide a small size and highly reliable optical device having an excellent optical characteristics with low cost such that each optical element can be bonded easily and firmly with a sufficient bonding strength without using an adhesive and generation of outgas and degradation of its bonded surface can be prevented. Moreover, according to the present invention, after each optical elements are previously bonded without using an adhesive, the bonded elements are fixed on a base, so that a highly reliable optical component can be provided with low cost without generation of outgas and degradation of its bonded surface, and a small size optical isolator having a sufficient bonding strength can be accomplished.

### BRIEF EXPLANATION OF THE DRAWINGS

FIG. 1 is a flow chart showing one example of a bonding method of the present invention.

FIG. 2 is a schematic view showing a construction of optical elements bonded in Example 1.

FIG. 3 is a cross sectional view showing a bonding type optical isolator manufactured in Example 2.

FIG. 4. is a graph showing the results of the measurements of extinction ratio of each optical isolator having a different thickness of buffer glasses (transparent optical materials) in the first aspect of the present invention.

FIG. 5 is a schematic view showing a construction when an extinction ratio of the optical isolator is measured in the first aspect of the present invention.

FIG. 6 shows one example of a construction of optical isolator in the second aspect of the present invention.

FIG. 7 is an explanation view of the process in Example 3 that each optical element is bonded to each other without using an adhesive to form a bonded body.

FIG. 8 is an explanation view of the process of fixing a formed bonded body and permanent magnets on a flat plate in Example 3.

FIG. 9 shows a bonding method for forming a conventional optical isolator.

### PREFERRED EMBODIMENTS OF THE INVENTION

Hereinafter, embodiments of the present invention will be explained. However, the present invention is not limited thereto.

In order to provide the optical device such that each optical element is bonded on each light transmissive surface with a sufficient bonding strength without using an adhesive and degradation of optical characteristics can be suppressed even when optical elements of which linear expansion coefficients are different from each other are bonded, the present inventors have found that if the optical device and the method for producing the optical device as shown below are employed, a small size and highly reliable optical device having excellent optical characteristics and the production method thereof can be provided. And consequently, they accomplished the present invention.

Namely, according to the present invention, there is provided an optical device, which is formed by bonding two polarizers to both surfaces of a magnetic garnet crystal directly or through a transparent optical material without using an adhesive and which functions when light is transmitted through its bonded surface, wherein the optical device is formed with a sufficient bonding strength on either condition that

at least one or more of each linear expansion coefficient and thickness of the magnetic garnet crystal, the transparent optical material and the polarizer is controlled;

or that a bonded body, which is formed by bonding them directly or through the transparent optical material without using an adhesive, is fixed on a base.

Further, according to the present invention, there is provided a method for producing an optical device, which is formed by bonding two polarizers to both surfaces of a magnetic garnet crystal directly or through a transparent optical material without using an adhesive, wherein the formation of the optical device with a sufficient bonding strength is performed

by controlling at least one or more of each linear expansion coefficient and thickness of the magnetic garnet crystal, the transparent optical material and the polarizer;

or by forming a bonded body by bonding them directly or through the transparent optical material without using an adhesive, and then fixing the bonded body on a base.

First, in the first aspect of the present invention, in order to provide a small size and highly reliable optical device, the present inventors have found that as the optical device that each optical element is bonded on its light transmissive surface with a sufficient bonding strength without using an adhesive, and there is no damage affected to antireflection films of each optical element while bonding, and moreover degradation of optical characteristics can be suppressed even when optical elements of which linear expansion coefficients are different from each other are bonded, it would be very effective to provide the optical device, which is formed by bonding a magnetic garnet crystal to a polarizer through a transparent optical material, such that a linear expansion coefficient of the transparent optical material is controlled and each thickness of the transparent optical material and the polarizer is properly selected, and the present invention has been accomplished by defining various conditions about bonding for practically utilizing these findings.

Namely, the first aspect of the present invention is an optical device, which is formed by bonding two polarizers to both surfaces of a magnetic garnet crystal through transparent optical materials without using an adhesive and which functions when light is transmitted through its bonded surface, wherein a linear expansion coefficient of the transparent optical material a 2 (/° C.) take a value between a linear expansion coefficient of the magnetic garnet crystal α1 (/° C.) and a linear expansion coefficient of the polarizer α3 (/° C.), a thickness of the transparent optical material t2 (mm) is t2≧0.02 mm, and a thickness of the polarizer t3 (mm) is 0.02 mm≦t3≦0.3 mm. And according to such an optical device, a small size and highly reliable optical device having a sufficient bonding strength and practical-level optical characteristics can be provided with low cost.

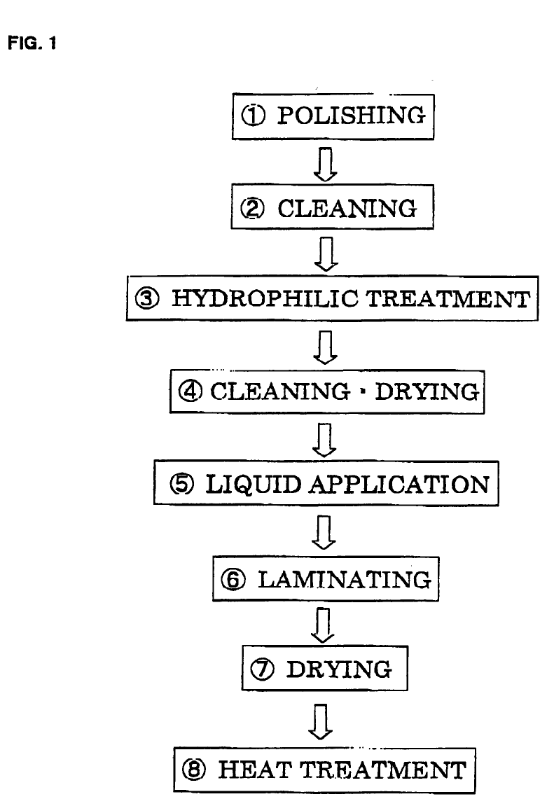

FIG. 1 shows one example of a bonding method when a bonding between the magnetic garnet crystal and the transparent optical material and/or a bonding between the transparent optical material and the polarizer are performed in the first aspect of the present invention.

First, each surface to be bonded (bonded surface) of the magnetic garnet crystal, the transparent optical material and the polarizer is sufficiently subjected to a polishing process (stop \mathring{1}). And then, each bonded surface of the optical elements Is adequately subjected to cleaning (step \mathring{2}) and subjected to hydrophilic treatment (step \mathring{3}). On this occasion, common wet cleaning is effective for cleaning \mathring{2} of each bonded surface. However, it is more effective for the cleaning to use an ultraviolet ray radiation process (UV process) or plasma process at the same time. Also, it is effective for the hydrophilic treatment \mathring{3} to use mixed solution of ammonia water, hydrogen peroxide solution and pure water, which is generally used for a semiconductor SOI wafer process, a diluted solution of nitric acid or hydrochloric acid, or a solution made by adding a hydrogen peroxide solution to these diluted solution.

Next, each optical element is subjected to cleaning by use of pure water to eliminate a hydrophilic treatment solution. After the pure water cleaning, it is preferable that the optical elements are dried by an IPA vapor drying method or spin dryer to prevent unevenness of drying (step \mathring{4}).

Each bonded surface of pretreated optical elements obtained as above may be bonded directly. However, in order to bond them easier, liquid is applied on each bonded surface (step \mathring{5}), and then the magnetic garnet crystal is laminated to the polarizer through the transparent optical material (step \mathring{6}) In this case, as for the liquid to be applied, the liquid based on a polar molecule such as water or alcohol can be used by itself or by mixture, and particularly, it is preferable that they are bonded through pure water. Also, it is possible to improve a bonding strength by adding a soluble material such as silicate to the liquid.

A bonded body laminated by the above procedure is subjecting to natural drying or vacuum drying, so that it is fixed with a weak bonding strength (step \mathring{7}). In this case, if each optical element does not have sufficiently flat surface, an air space is generated between each bonded surface of the optical elements, and it causes delamination. In order to solve this problem, it is effective that a thickness of the polarizer is set 0.3 mm or less. The following is the explanation of its mechanism.

Generally, the strength required for bending a thin plate is in proportion to the cube of a thickness of the thin plate. Therefore, if a thickness of materials to be bonded is getting thinner, it is hard to generate delamination because the materials easily cling to unevenness of the surface to fill an air space. In the case of the magnetic garnet crystal, since a desired Faraday rotation angle can be obtained by multiplying Faraday rotation coefficient by its thickness, a magnetic garnet crystal can not be thinned in order to increase a bonding strength. On the other hand, in the case of a polarizer, particularly a polarizing glass, if it has a thickness of 0.02 mm or more, a sufficient extinction characteristic can be obtained. Therefore, a polarizer can be thinned in order to improve the adhesion.

Practically, a polarizing glass was gradually thinned and its adhesion after the drying process of the step \mathring{7} was confirmed. As the result, it was confirmed that when a thickness of the polarizing glass was 0.3 mm or less, generation of delamination could be reduced and the bonding was sufficient.

After the drying process of the step \mathring{7} is performed, an obtained bonded body is subjected to a heat treatment at a temperature of about 80-200° C. for several hours, so that a sufficient bonding strength can be obtained (step \mathring{8}). On this occasion, if the rate of heating in the heat treatment process is too fast, there is the possibility that delamination of the bonded surface is generated during heating. Therefore, it is preferable that the rate of heating is set at 20° C./h or less. Also, as to an atmosphere during a heat treatment, it is possible to perform it in an air, and it is more preferable to perform it in a low-pressure atmosphere.

According to the above steps, the optical device formed by directly bonding each optical element can be obtained.

Generally, in the case of an optical device, which is easily affected by strain of optical elements, for example an optical isolator or the like, there is a tendency that when bonded optical elements suffer from stress, the extinction ratio is decreased. Since an optical device formed by bonding each optical elements without using an adhesive, is firmly fixed, stress (thermal stress) in proportion to the difference of linear expansion coefficient among optical elements in added in accordance with the temperature change of the optical device.

Therefore, in the case of the optical device formed by directly bonding optical elements, degradation of the extinction ratio is generated in accordance with the temperature change. This degradation of the extinction ratio is generated with the temperature change of the optical device has a tendency that when the difference of linear expansion coefficient among optical elements is 2×10⁻⁶/° C. or more, the degradation of the extinction ratio is markedly generated. Generally, a linear expansion coefficient of a polarizing glass used as an optical element is 6.5×10⁻⁶/° C. and a linear expansion coefficient of a bismuth-substituted iron garnet crystal is 11×10⁻⁶/° C. Therefore, the difference of linear expansion coefficient between both elements is 4.5×10⁻⁶/° C. In the case of the optical device formed by directly bonding the polarizing glass to the bismuth-substituted iron garnet crystal, large degradation of the extinction ratio is generated. In this regard, the present invention intends to suppress the degradation of the extinction ratio by providing a transparent optical material between a polarizer and a magnetic garnet crystal wherein linear expansion coefficient of the transparent optical material takes a value between those of the polarizer and the magnetic garnet crystal. In this regard, as a material of the transparent optical material, a material such that light ray emitted from a light source can be transmitted therethrough, and its degradation amount of the extinction ratio is small can be used. As such materials, for example, various optical glasses of a soda lime glass, aluminosilicate glass, borosilicate glass, lead glass, barium glass and the like can be given.

The effect of suppressing degradation of an extinction ratio depends on a thickness of a transparent optical material, and the thickness is getting thicker, the suppressing effect of degradation of the extinction ratio is getting larger. This means that thermal stress applied between a polarizer and a magnetic garnet crystal can be relaxed by changing the shape of a transparent optical material. Namely, if the thickness of the transparent optical material is too thin, the effect of relaxing the thermal stress is not acted sufficiently. Therefore, the thickness of the transparent optical material is preferably 0.02 mm or more, and more preferably 0.05 mm or more. Also, the upper limit of the thickness of a transparent optical material depends on a limitation of the size of a desired optical device. In the case of an optical isolator or the like, in many cases, its optical distance is 5 mm or less. And, in consideration of a thickness of optical elements except the transparent optical material, the thickness is preferably 1 mm or less.

Also, as for the above direct building method, on the occasion when a magnetic garnet crystal is bonded to a transparent optical material, after a metal oxide film is formed on a bonded surface facing the transparent optical material of the magnetic garnet crystal, the magnetic garnet crystal is bonded to the transparent optical material, so that the formed metal oxide film acts as an antireflection film and its bonding strength can be increased more. In this regard, it is preferable that the metal oxide film formed on the bonded surface of the magnetic garnet crystal is chemically stable and transparent within the range of a communication wavelength region (0.9-1.7 μm), and more preferable that its surface layer is easily subjected to hydrophilic treatment. Accordingly, since the metal oxide film is composed of one kind or two or more kinds of metal oxide films selected from Al₂O₃, TiO₂, and SiO₂, and which is laminated in single-layer or multilayer, large effect as an antireflection film can be obtained and its bonding strength can be improved, so that a highly reliable optical device can be formed.

Moreover, in the second aspect of the present invention, in order to accomplish the second object of the present invention, the present inventors have considered that in many ways that a small size and highly reliable optical isolator is provided with low cost, and as the result, they have found that as for the optical isolator, which is formed by fixing at least two polarizers, a magnetic garnet crystal and permanent magnets, which put the magnetic garnet crystal in the magnetic field for saturation, on a base, if a bonded body formed by bonding the polarizers to the magnetic garnet crystal directly or through the transparent optical material without using an adhesive is fixed on the base, a bonding strength among the optical elements and a fixing strength between the bonded body and the base can be sufficiently increased and obtained surely, and it is effective to miniaturize the optical isolator. Accordingly, the present invention has been accomplished by defining various conditions about bonding for practically utilizing this finding.

The following is the detailed explanation about the construction regarding miniaturization of an optical isolator and a bonding method in the second aspect of the present invention.

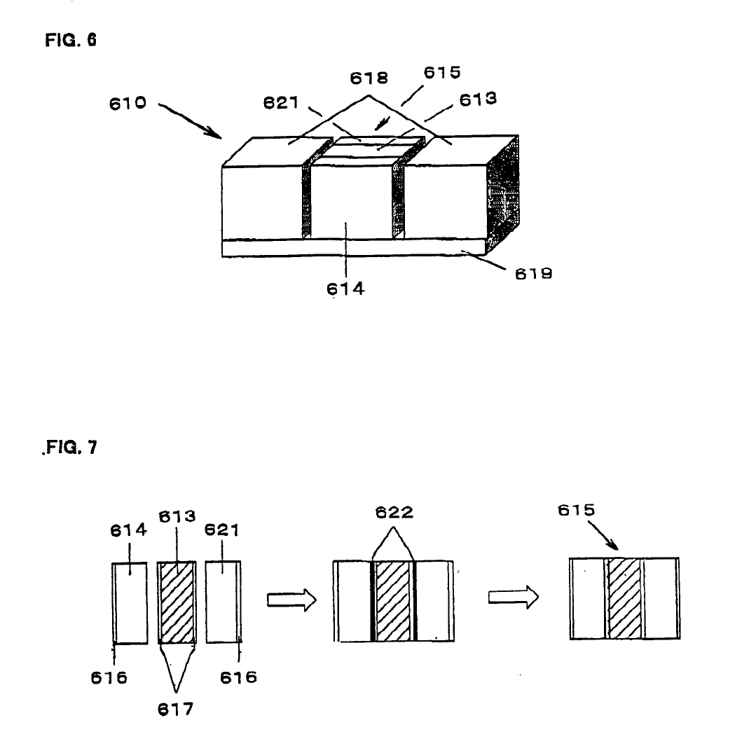

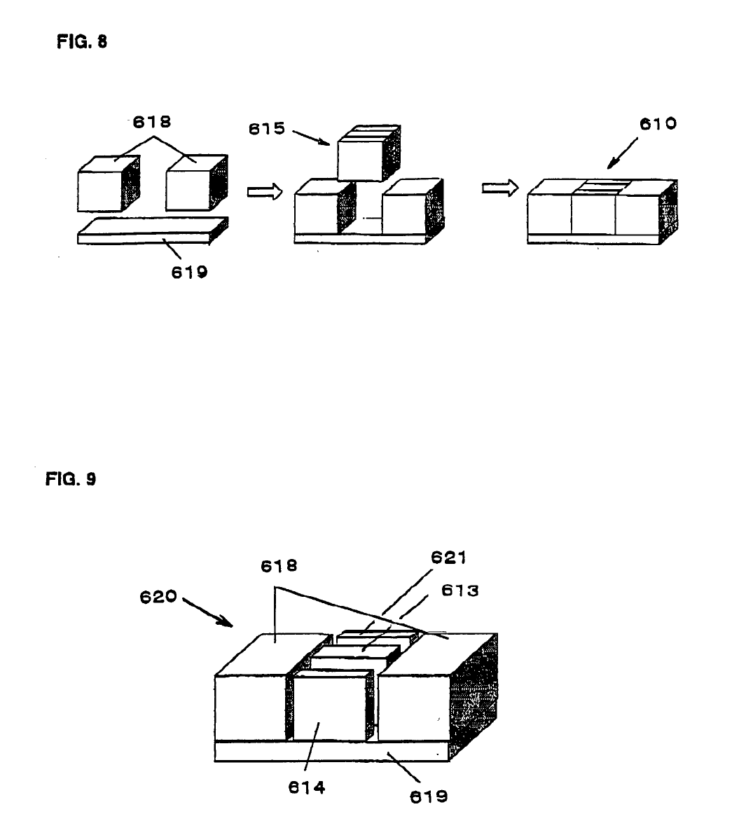

FIG. 6 is an explanatory view showing one example of a construction of optical elements bonded by the method of the present invention and an optical isolator completed by fixing an obtained bonded body and a permanent magnet on a baes. FIG. 7 is an explanation view of the process that each optical element is bonded to each other without using an adhesive to form a bonded body. Also, FIG. 8 is an explanation view of the process that a completed bonded body and permanent magnets are fixed on a base. In these figures, a flat plate is used as the base. However, the present invention is no limiting to this, for example, it is possible to use a case in the form of a cylindrical shape or the like as the base.

The construction of an optical isolator 610 shown in FIG. 6 is that a polarizer 614, a magnetic garnet crystal serving as a Faraday rotator 613 and an other polarizer 621 are bonded directly or through a transparent optical material (not shown) without using an adhesive to form a bonded body 615, and the bonded body 615 and permanent magnets 618 are fixed on a flat plate 619 by use of a bonding material.

In order to form this bonded body, it is preferable that each bonded surface of the optical elements is sufficiently subjected to mirror polishing until each bonded surface has a predetermined surface roughness and warp.

Next, antireflection films made of a metal oxide film optimized in regard to each refractive index of optical elements (the polarizer 614 and the other polarizer 621) opposed to both bonded surfaces of the Faraday rotator 613 is previously formed. For example, antireflection films for a glass 617 are formed on both sides or the Faraday rotator 613. On the other hand, antireflection films for an air 616 are formed on the other surface of a bonded surface of the polarizer 614 and the other polarizer 621 (both made of a polarizing glass), respectively.

In this case, it is possible that the metal oxide films 617 formed on the Faraday rotator 613 are composed of one kind or two or more kinds of metal oxide films selected from Al₂O₃, TiO₂ and SiO₂, and the metal oxide films are laminated in single-layer or multilayer. According to this, the metal oxide films sufficiently function as antireflection films and the boding strength can be improved.

The metal oxide films can be formed by a common electron beam deposition method. The metal oxide films laminated in single-layer or multilayer are deposited up to the thickness such that a transmitted light is not reflected (several dozen to several hundred nanometers).

Next, surfaces of the metal oxide films 617 formed on both sides of the Faraday rotator 613 are used as bonded surfaces, and each bonded surface of the polarizer 614 and the other polarizer 621 is bonded to the bonded surfaces of the Faraday rotator 613 respectively without using an adhesive directly or through a transparent optical material (not shown), so that a bonded body 615 having a strong bonding strength and no adverse effect on optical characteristics can be produced.

In this case, the bonding among the Faraday rotator, the polarizer, the other polarizer and the transparent optical material are performed by, at first, subjecting each bonded surface to mirror-polishing (in the case of the Faraday rotator, mirror polishing is performed before forming metal oxide films thereon), cleaning, hydrophilic treatment and drying process; laminating them directly or through water; and then subjecting them to a heal treatment.

In the mirror polishing, a common wet mirror polishing in performed so that each optical element has desired values of a surface roughness (Ra (nm)) and a warp (curvature radius (m)), for example, in the cases of the polarizing glass and the transparent optical material, Ra=0.3 nm or less and a warp=60 m or more, and in the case of the Faraday rotator, Ra=0.3 nm or less and a warp=20 m or more.

Next, after each bonded surface of the optical elements is sufficiently subjected to cleaning, they are subjected to a hydrophilic treatment. (In the case of the Faraday rotator, the cleaning and the hydrophilic treatment are performed after metal oxide films are formed on the bonded surface.) A common wet cleaning is effective for cleaning. However, it is more effective for the cleaning to use an UV process or plasma process at the same time. Also, it is effective for the hydrophilic treatment to use mixed solution of ammonia water, hydrogen peroxide solution and pure water, which is generally used for a semiconductor SOI wafer process, a diluted solution of nitric acid or hydrochloric acid, or a solution made by adding a hydrogen peroxide solution to these diluted solution. Next, optical elements are subjected to cleaning by use of pure water to eliminate a hydrophilic treatment solution. After the pure water cleaning, it is preferable that the optical elements are dried by a spin dryer or the like to prevent unevenness of drying.

Each Bonded surface of pretreated optical elements obtained as above is laminated to each other directly or through water 622. The laminating can be more easily perforated when water lies between each bonded surface. At this moment, it is preferable that an extinction ratio is measured by transmitting laser through each of optical elements, the optical elements are fixed at the angle when a measured value is maximized, and they are stuck to each other.

The optical elements laminated by the above procedure are subjecting to natural drying or vacuum drying, so that they are bonded with a weak bonding strength. Those are subjected to a heat treatment at a temperature of about 80-200° C. for several hours, so that a sufficient bonding strength can be obtained. On this occasion, if the rate of healing in the heat treatment step is too fast, there is the possibility that delamination is generated on the bonded surface during heating. Therefore, it is preferable that the rate of heating is set at 20° C./h or less. Also, as to an atmosphere during a heat treatment, it is possible to perform it in an air, and it is more preferable to perform it in a low-pressure atmosphere. The bonding of the optical elements can be completed through the above steps to form a bonded body.

Next, the step of fixing a completed bonded body 615 and permanent magnets 618 on a flat plate 619 is performed (see FIG. 8).

First, for example, gold-tin type high temperature solder chips (not shown) are placed on the flat plate 619, and the high temperature solder chips on the flat plate 619 are melted by RF heating. When the solder chips are melted, the RF healing is stopped, and then the permanent magnets 618 are fixed on the flat plate 619 by pressing them on the melted solder during the process of falling in a temperature of the solder. Generally, in order to give sufficient magnetic field to the bonded body 615, one or two permanent magnet 618 is disposed near the bonded body 615. In the case that two permanent magnets are disposed, two permanent magnets 618 are disposed with such a space as to insert the bonded body 615 therebetween and fixed on the flat plate 619.

Next, a material having a lower melting point than the aforementioned gold-tin type high temperature solder, for example, a low-melting glass powder (not shown) is placed on a part of the flat plate 619 on which the bonded body is fixed, and the flat plate 619 and the glass powder are heated again by RF heating at the temperature, which is higher than a melting point of the low-melting glass but lower than the high temperature solder. When the glass powder is melted, the RF heating is stopped, and then the bonded body 615 is fixed on the flat plate 619 by pressing it on the melted glass during the process of falling in a temperature or the glass.

In this case, it is also possible that the bonded body 615 and the permanent magnets 618 (or the bonded body 615, the permanent magnets 618 and the flat plate 619), which are materials to be bonded are heated at a temperature higher than a melting point of the solder or the glass, and then they are bonded by pressing them on the solder chips or the glass powder of the flat plate 619.

Through the above steps, each optical element is bonded to each other without using an adhesive to form a bonded body, and then an optical isolator formed by fixing the bonded body and the permanent magnets on the flat plate can be completed.

In the case that the Faraday rotator in the bonded body, which constitutes the optical isolator of the present invention, is a bismuth-substituted iron garnet crystal and the polarizer in the bonded body is polarizing glass, when a bonded body is, for example, formed by bonding two polarizers made of a polarizing glass to a Faraday rotator made of a bismuth-substituted iron garnet crystal, the Faraday rotator that metal oxide films are formed on both sides thereof can function effectively as a bonding material without adversely affecting on optical characteristics

Also, in the case that the Faraday rotator in the bonded body, which constitutes the optical isolator of the present invention, is a bismuth-substituted iron garnet crystal, it is realizable to obtain a Faraday rotation angle of 45° on its thickness of about 0.5 mm, so that it is effective for miniaturizing an optical isolator. Also, in the case that the polarizer is polarizing glass of which optical characteristic are hardly influenced by its thickness, they can be thinned, and therefore, it is effective for miniaturizing the optical isolator.

Also, as a material of the transparent optical material, which constitutes the bonded body of the optical isolator of the present invention, a material such that light ray emitted from a light source can be transmitted therethrough and its degradation amount of an extinction ratio is small can be used. As such a material, for example, various optical glass, of a soda lime glass, aluminosilicate glass, borosilicate glass, lead glass, barium glass and the like can be given.

### EXAMPLE

Hereinafter the present invention will be explained specifically with reference to the following examples and comparative examples. However the present invention is not limited thereto.

First, the first aspect of the present invention will be explained with reference to example 1 and example 2.

### Example 1

As optical elements, various polarizing glasses (polarizers) having different thickness respectively, buffer glasses (transparent optical materials), and Faraday rotators (bismuth-substituted iron garnet crystal adjusted by a wavelength of 1.31 μm to θf=45°) were prepared, and these optical elements were subjected to polishing sufficiently to adjust a surface roughness to 0.3 nm or less.

After that, as for the Faraday rotator, the Faraday rotators in which antireflection films for a buffer glass (a single layer film of Al₂O₃, TiO₂ or SiO₂, or a three-layered film of Al₂O₃/TiO₂/SiO₂) were formed on both sides thereof and the Faraday rotators in which antireflection films for a glass were not formed thereon were prepared. On the other hand, as for the polarizing glasses, an antireflection film for an air (a film of Al₂O₃/SiO₂) was formed on only an unbonded surface of each polarizing glass. In this regard, these antireflection films wore optimized by a wavelength of 1.31 μm. Detailed physical properties of the optical elements are shown in Table 1 as follows. The data of the optical elements shown in Table 1 were obtained from the measurements of the polarizing glasses that the antireflection film was formed on the unbonded surface thereof and the Faraday rotators that the antireflection films were formed on both sides thereof.

TABLE 1

| | Polarizing glass | Butter glass | Faraday rotator |
|---|---|---|---|
| Surface roughness | 0.2˜0.3 | 0.15˜0.2 | 0.15˜0.2 |
| (R_{M} (nm)) | | | |
| Warp | 60˜80 | 60˜80 | 80˜150 |
| (Curvature radius (m)) | | | |
| Coefficient of linear | 6.5 × 10⁻⁶ | 8.5 × 10⁻⁶ | 11 × 10⁻⁶ |
| Expanaion | | | |
| (/° C.) | | | |
| Thickness | 0.1˜0.5 | 0.1 | 0.05 |
| (mm) | | | |

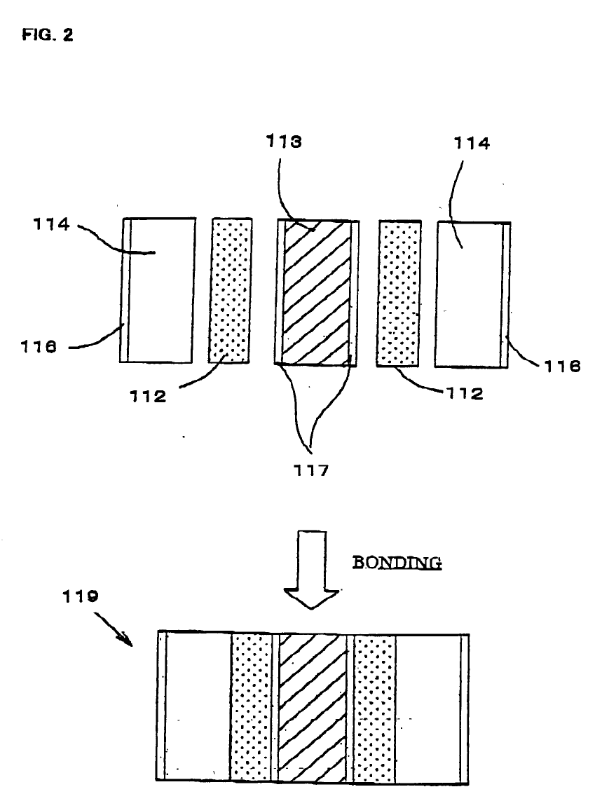

Next, FIG. 2 shows the construction of the optical device which is integrated by bonding. FIG. 2 shows the case of using the Faraday rotators 113 that antireflection films for a buffer glass 117 are formed thereon. An optical device 119 was produced by bonding a bonded surface (the surface on which the antireflection film for an air are not formed) of the polarizer 114 to a bonded surface of the Faraday rotators 113 through the buffer glass (the transparent optical material) 112.

The bonding procedure of the optical device was conducted in accordance with a flow shown in FIG. 1. Main production conditions in each step are shown as follows.

\mathring{1} Polishing: each optical element is subjected to polishing so that a surface roughness has the value shown in Table 1.

\mathring{2} Cleaning: after UV (Ultraviolet light) treatment by use of a low-pressure mercury lamp, each optical element is subjected to cleaning (US (Ultra Sonic) cleaning) with pure water.

\mathring{3} Hydrophilic treatment: each optical element is immersed in mixed solution of ammonia water:hydrogen peroxide solution:pure water=1:1:4.

\mathring{4} Cleaning and Drying: after cleaning (US cleaning) with pure water, IPA vapor drying is performed.

\mathring{5} Liquid application: pure water in applied to each bonded surface of the optical elements.

\mathring{6} Laminating: the polarizing glasses are bonded to the Faraday rotator through the buffer glasses before the applied liquid is dried. In this case, each polarized wave direction of the two polarizing glasses is adjusted to 45° to each other.

\mathring{7} Drying: after laminating, vacuum drying is performed for 24 hours.

\mathring{8} Heat treatment: a heat treatment is performed at a temperature of 110° C. for 10 hours in an air. A heating rate is 4° C./h.

After the drying of the step \mathring{7} was performed, each bonded surface of obtained bonded bodies was examined to evaluate an adhesiveness. The results are shown in Table 2. As clear from Table 2, when a thickness of a polarizing glass was 0.3 mm or less, large delamination was not generated and adhesiveness was improved. Moreover, it was confirmed that in the case that metal oxide films were formed on the Faraday rotator, regardless of its form of the antireflection film, i.e., a single layer film or a three layered film, delamination was not generated on the bonded surface between the optical elements and adhesiveness was further improved.

TABLE 2

| Thickness of | Oxide films are formed | | | | |
|---|---|---|---|---|---|
| Polarizing | | | | Three | No oxide |
| Glass (mm) | Al₂O₃ | TiO₂ | SiO₂ | Layered Film | films |
| 0.10 | ◯ | ◯ | ◯ | ◯ | ◯ |
| 0.15 | ◯ | ◯ | ◯ | ◯ | Δ |
| 0.20 | ◯ | ◯ | ◯ | ◯ | Δ |
| 0.25 | ◯ | ◯ | ◯ | ◯ | Δ |
| 0.30 | ◯ | ◯ | ◯ | ◯ | Δ |
| 0.35 | Δ | Δ | ◯ | ◯ | X |
| 0.40 | Δ | Δ | Δ | Δ | X |
| 0.50 | X | X | X | X | X |

◯: No delamination,
Δ: Small delamination,
X: Large delamination,

Next, after the heat treatment of the step \mathring{8} was performed, an obtained bonded body (an optical device) was cut into a chip of 1 mm×1 mm by a dicer. The chip was treated by a pressure cooker at a temperature of 105° C. for 100 hours, and then the bonded surface thereof was observed to evaluate durability of the bonded surface. The results are shown in Table 3 as follows.

TABLE 3

| Thickness of | Oxide films are formed | | | | |
|---|---|---|---|---|---|
| Polarizing glass | | | | Three | No oxide |
| (mm) | Al₂O₃ | TiO₂ | SiO₂ | layered film | films |
| 0.10 | ◯ | ◯ | ◯ | ◯ | Δ |
| 0.15 | ◯ | ◯ | ◯ | ◯ | Δ |
| 0.20 | ◯ | ◯ | ◯ | ◯ | Δ |
| 0.25 | ◯ | ◯ | ◯ | ◯ | Δ |
| 0.30 | Δ | Δ | ◯ | ◯ | Δ |
| 0.35 | Δ | Δ | Δ | Δ | — |
| 0.40 | X | X | Δ | Δ | — |
| 0.50 | — | — | — | — | — |

◯: No erosion,
Δ: Small erosion,
X: Large erosion,
—: Not evaluated.

As shown in Table 3, when a thickness of the polarizing glass was 0.3 mm or less, an optical device of which the erosion on the bonded surface was reduced can be obtained. Also, in the case that metal oxide films were formed on the Faraday rotator, its bonding strength was further improved, so that a high reliable optical device having a sufficient boding strength can be obtained.

### Example 2

Next, the experiment about influence of a thickness of the transparent optical material on optical characteristics was performed. As optical elements, polarizing glasses (polarizers), buffer glasses (transparent optical materials) and Faraday rotators (bismuth-substituted iron garnet crystals adjusted by a wavelength of 1.31 μm to θt=45°) were prepared. In this experiment, each thickness of polarizing glasses after forming oxide films thereon was 0.3 mm, and buffer glasses having various thicknesses of 0.01-0.30 mm were prepared. Also, Faraday rotators were adjusted in order to obtain θf=45° at a temperature when optical characteristics of optical isolators were measured, and only three layered films of Al₂O₃/TiO₂/SiO₂ as antireflection films for a buffer glass were formed on both sides thereof. The other properties of each optical element were the same as Example 1. As for a bonding procedure of the optical elements, optical elements were bonded by the same procedure as Example 1 to produce optical devices. Also, for the sake of comparison, optical devices formed by directly bonding polarizing glasses to Faraday rotator without transparent optical materials were manufactured.

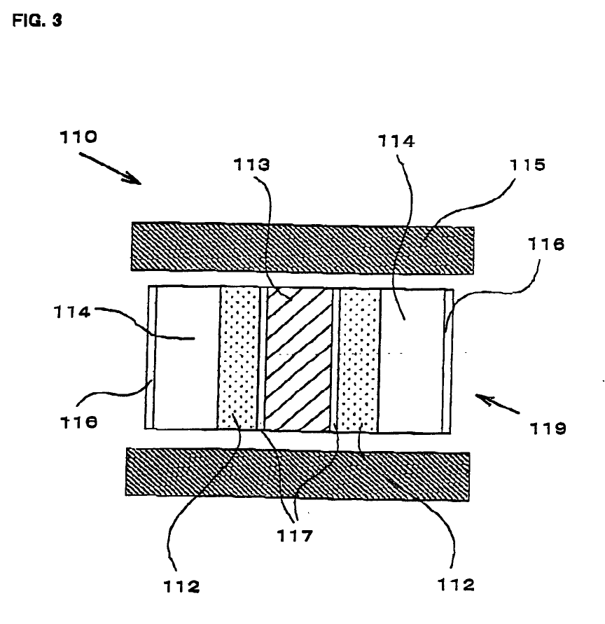

Next, as shown in FIG. 3, an obtained optical device 119 was cut into a chip of 1×1 mm, and it was placed in a cylindrical magnet 115 to form an optical isolator 110. And then, measurement of an extinction ratio for obtained optical isolators of which buffer glasses 112 have various thickness was performed. As shown in FIG. 5, the measurement was performed by the procedure that light 122 emitted from a light source (not shown) was transmitted through the optical isolator 110, and the transmitted light 122 was detected by a detector 121. On this occasion, the measurement temperature was set at a temperature which is 40° C. lower than the optical material temperature in step \mathring{7}. By setting the temperature as described above, an extinction ratio can be measured in a state that a thermal stress was applied to the bonded surface.

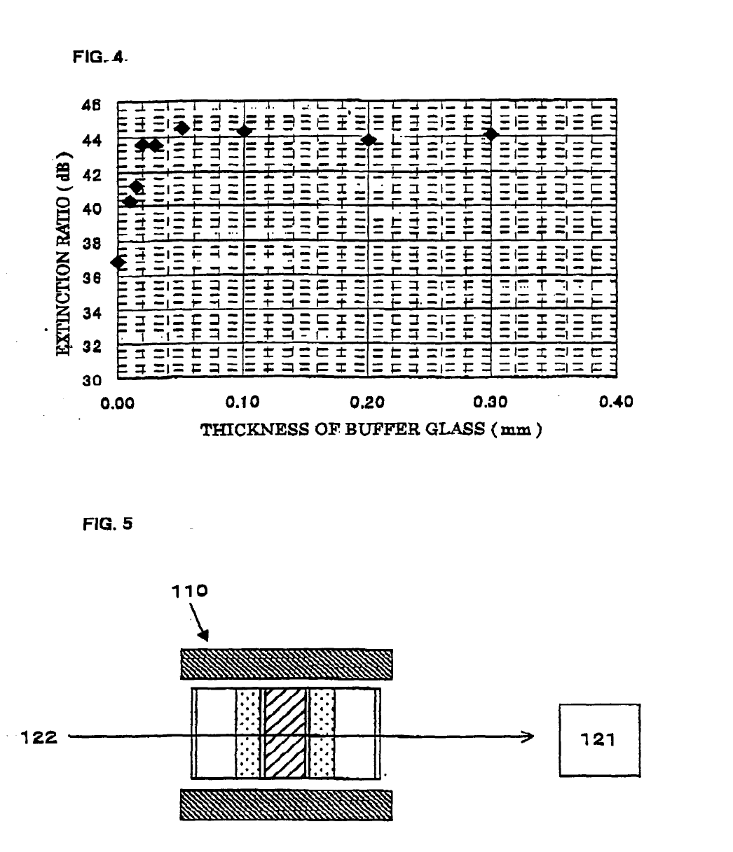

FIG. 4 shows the results of the measurement of an extinction ratio of the optical isolators of which buffer glasses have various thicknesses. As shown in FIG. 4, it was confirmed that when a thickness of the buffer glass was 0.02 or more, degradation of the extinction ratio could be reduced.

Next, the second aspect of the present invention will be explained with reference to Example 3 and Comparative example 1.

### Example 3

First, stops for completing a bonded body by laminating each optical element without using an adhesive will be explained.

Optical elements used in this bonding were two polarizers (polarizing glasses) of 15 mm square and a thickness of 0-2 mm, and a Faraday rotator (a bismuth-substituted iron garnet crystal) of 15 mm square and a thickness of 0.45 mm. After subjecting bonded surfaces of these optical elements to polishing sufficiently, antireflection films for a glass (TiO₂/Al₂O₂/SiO₂) were formed on both sides of the Faraday rotator (made of a bismuth-substituted iron garnet crystal adjusted by a wavelength of 1.55 μm to θf=45°). On the other hand, an antireflection film for an air (Al₂O₃/SiO₂) was formed on only an unbonded surface of the polarizing glass. In this regard, these antireflection films were optimized by a wavelength of 1.55 μm.

After subjecting the optical elements to UV treatment by use or a low-pressure mercury lamp, they were subjected to ultra sonic cleaning with pure water. And then, each optical element was immersed in mixed solution of ammonia water:hydrogen peroxide solution:pure water=1:1:4 as hydrophilic treatment. Subsequently, each optical element was subjected to ultra sonic cleaning with pure water to eliminate the mixed solution and subjected to IPA vapor drying. The Faraday rotator was put between two polarizing glasses through water applied on each bonded surface to laminate in tight contact. In this case, each polarized wave direction of the two polarizing glasses was adjusted to 45° to each other, and they were fixed. After laminating, vacuum drying was performed for 24 hours to dehydrate the bonded surfaces. After that, a heat treatment was performed at a temperature of 110° C. for 10 hours in a low pressure atmosphere at a pressure of 0.2 atmosphere to complete a strong bonding. In this case, A heating rate was 4° C./h.

A bonded body bonded by the above procedure was cut into a chip of 1 mm×1 mm by a dicer, and the bonded body was completed.

Next, the step of fixing the completed bonded body and permanent magnets on a flat plate was performed.

First, a flat plate made of stainless (SUS304) (of which length was 0.85 mm, width was 3.2 mm and thickness was 0.5 nm) was used, and it was gilded to enable soldering. Also, Sm—Co type magnets were used and each magnet was processed to have a size of 1 mm×1 mm×0.85 mm. These magnets were also gilded to enable soldering.

A gold-tin type high temperature solder chips (melting point: 200° C.) were placed on a portion of the flat plate on which the permanent magnets were fixed, and which was heated at a temperature of 350° C. by RF heating to melt it. When the solder chips were melted, RF heating was stopped, and the two permanent magnets were fixed on the flat plate by pressing them on the melted solder during the process of falling in a temperature of the solder.

Next, a low-melting glass powder (softening point: 184° C.) was placed on the portion where the bonded body was fixed, and the flat plate was heated at a temperature of 250° C. by RF heating. When the low-melting glass powder was melted, RF heating was stopped, and the bonded body was fixed on the flat plate by pressing it on the melted low-melting glass powder during the process of falling in a temperature of the low-melting glass.

After that, the permanent magnets were magnetized to complete an optical isolator. The length of the optical isolator in a light transmission direction was 0.85 mm.

Reverse direction insertion loss of this optical isolator was measured by laser having a wavelength of 1.55 μm. Optical characteristics of the optical isolator in Example 3 are shown in Table 4.

TABLE 4

| | Forward | Reverse | | Forward | Reverse |
|---|---|---|---|---|---|
| | direction | direction | | direction | direction |
| Sample | insertion | insertion | Sample | insertion | insertion |
| number | loss (dB) | loss (dB) | number | loss (dB) | loss (dB) |
| 1 | 0.10 | 44 | 7 | 0.12 | 44 |
| 2 | 0.11 | 43 | 8 | 0.10 | 43 |
| 3 | 0.11 | 45 | 9 | 0.12 | 43 |
| 4 | 0.10 | 44 | 10 | 0.11 | 42 |
| 5 | 0.12 | 42 | 11 | 0.11 | 44 |
| 6 | 0.11 | 43 | Average | 0.11 | 43 |

As clear from Table 4, an average value of eleven forward direction insertion losses was 0.11 dB, and an average value of eleven reverse direction insertion losses was 43 dB. It was confirmed that the optical isolator of the present invention has sufficiently favorable optical characteristics and the values thereof were stable.

An impact resistance test was performed for this optical isolator. Accelerated velocities of 500 G, 1000 G and 2000 G were employed, and eleven optical isolator samples were used for the test. Bonding conditions of each component and a bonded surface of the bonded body before and after the impact resistance test were observed. The results of the impact resistant test of the optical isolator in Example 3 are shown in Table 5.

TABLE 5

| | 500 G | | 1000 G | | 2000 G | |
|---|---|---|---|---|---|---|
| Sample | Compo- | Bonded | Compo- | Bonded | Compo- | Bond |
| number | nent | surface | nent | surface | nent | Surface |
| 1 | ◯ | ◯ | ◯ | ◯ | ◯ | ◯ |
| 2 | ◯ | ◯ | ◯ | ◯ | ◯ | ◯ |
| 3 | ◯ | ◯ | ◯ | ◯ | ◯ | ◯ |
| 4 | ◯ | ◯ | ◯ | ◯ | ◯ | ◯ |
| 5 | ◯ | ◯ | ◯ | ◯ | ◯ | ◯ |
| 6 | ◯ | ◯ | ◯ | ◯ | ◯ | ◯ |
| 7 | ◯ | ◯ | ◯ | ◯ | ◯ | ◯ |
| 8 | ◯ | ◯ | ◯ | ◯ | ◯ | ◯ |
| 9 | ◯ | ◯ | ◯ | ◯ | ◯ | ◯ |
| 10 | ◯ | ◯ | ◯ | ◯ | ◯ | ◯ |
| 11 | ◯ | ◯ | ◯ | ◯ | ◯ | ◯ |

◯. . . No detachment and good condition (component)/No delamination and better bonding (bonded surface).

It was confirmed that even after the impact resistance test, the bonding conditions of each optical element and the bonded surfaces of the bonded body have favorable and sufficient reliability.

### Comparative Example 1

Optical elements used therein were two polarizers (polarizing glasses) of 15 mm square and a thickness of 0.2 mm, and a Faraday rotator (a bismuth-substituted iron garnet crystal) of 15 mm square and a thickness of 0.45 mm. Antireflection films (Al₂O₃/SiO₂) were formed on both sides of the Faraday rotator (made of a bismuth-substituted iron garnet crystal adjusted by a wavelength of 1.55 μm to θf=45°) and both sides of the polarizing glass, respectively. In this regard, these antireflection films were optimized by a wavelength of 1.55 μm.

The polarizers were cut into a chip of 1 mm×1 mm so that a polarized direction or the polarizer corresponded to a side direction of the cut square and a polarized direction of the other one corresponded to a diagonal direction of the cut square. Also, the Faraday rotator was also cut into a chip of 1 mm×1 mm. One side of lateral faces of each optical element was provided with a deposition layer made of gold to enable fixation by solder.

A flat plate made of stainless (SUS304) (of which length was 1.05 mm, width was 3.2 mm and thickness was 0.5 mm) was used, and it was gilded to enable soldering. Also, Sm—Co type magnets were used and each magnet was processed to have a size of 1 mm×1 mm×1.05 mm. These magnets were also gilded to enable soldering.

A gold-tin type high temperature solder chips (melting point: 280° C.) were placed on a portion of the flat plate on which each member was fixed, and two polarizers, the Faraday rotator and the permanent magnets were disposed thereon. In this case, spaces of 0.1 mm among the polarizers and the Faraday rotator were provided to secure airspace. Each member was covered with a stainless plate, and heated at a temperature of 350° C. by RF heating to melt solder. And then, the heating by RF heating was stopped, and each member was fixed on the flat plate by pressing each optical element on the melted solder under pressure of the stainless plate during the process of falling in a temperature of the solder.

After that, the magnets were magnetized to complete an optical isolator. The length of the optical isolator in a light transmission direction was 1.05 mm.

A reverse direction insertion loss of this optical isolator was measured by laser having a wavelength of 1.55 μm. Optical characteristics of the optical isolator in the comparative example 1 are shown in Table 6.

TABLE 6

| | Forward | Reverse | | Forward | Reverse |
|---|---|---|---|---|---|
| | direction | direction | | direction | direction |
| Sample | insertion | insertion | Sample | insertion | insertion |
| number | loss (dB) | loss (dB) | number | loss (dB) | loss (dB) |
| 1 | 0.17 | 86 | 7 | 0.10 | 39 |
| 2 | 0.10 | 34 | 8 | 0.10 | 42 |
| 3 | 0.16 | 39 | 9 | 0.14 | 36 |
| 4 | 0.15 | 38 | 10 | 0.15 | 39 |
| 5 | 0.14 | 39 | 11 | 0.15 | 38 |
| 6 | 0.10 | 40 | Average | 0.18 | 38 |

An average value of eleven forward direction insertion losses was 0.13 dB, and an average value of eleven reverse direction insertion losses was 30 dB. As compared to Example 3, it was confirmed that the optical characteristics were inferior to those of Example 3. Particularly, the results of the reverse direction insertion loss, which clearly indicate an angle deviation between the polarizer and the other polarizer, were significantly worse than those of Example 3, and variation of values of each isolator is large. It is conceivable that since an angle adjustment of two polarizers was not performed, the bad effect was revealed remarkably.

An impact resistance test was performed for this optical isolator. Accelerated velocities of 500 G, 1000 G and 2000 G were employed, and eleven optical isolator samples were used for the test. Bonding conditions of each component before and after the impact resistance test were observed. The results of the impact resistance test of the optical isolator in Comparative example 1 are shown in Table 7.

TABLE 7

| Sample | Components | | |
|---|---|---|---|
| number | 500 G | 1000 G | 2000 G |
| 1 | ◯ | X | X |
| 2 | ◯ | ◯ | X |
| 3 | ◯ | ◯ | ◯ |
| 4 | ◯ | ◯ | ◯ |
| 5 | ◯ | ◯ | ◯ |
| 6 | ◯ | ◯ | X |
| 7 | ◯ | X | X |
| 8 | ◯ | ◯ | X |
| 9 | ◯ | ◯ | ◯ |
| 10 | ◯ | ◯ | ◯ |
| 11 | ◯ | ◯ | X |

◯. . . No detachment and good condition
X . . . There is detachment and bad condition.

After the impact resistance test of 500 G, the optical isolators had no detachment of the components and had good conditions. However, after the impact resistance test of 1000 G, two out of eleven optical isolators had detachment of components. Moreover, after the impact resistance test of 2000 G, six out of eleven optical isolators had detachment of components. All of the detached components was a polarizer. It is conceivable that since the polarizer was made of a polarizing glass having a thickness of 0.2 mm, which had a very small bonded surface toward a flat plate, so that a sufficient bonding strength could not be obtained, and as the result, the component was detached in the impact resistance test.

As clear from the above results, as for the optical isolator according to the present invention, it is clear that since when a bonded body is produced, the angle adjustment of two polarizers is performed, so that these optical characteristics are favorable and stable. Also, since two polarizers and a Faraday rotator are closely bonded, the optical isolator can be miniaturized particularly in a light transmission direction. Moreover, it is clear that since after bonding optical elements to each other, they are fixed on a flat plate, a large area to be fixed and a sufficient fixing strength can be obtained.

The present invention is not limited to the embodiments described above. The above-described embodiments are mere examples, and those having the substantially same structure as that described in the appended claims and providing the similar functions and advantages are included in the scope of the present invention.

For example, in the above embodiments, there is provided an optical isolator formed by a minimum unit, i.e., by bonding polarizers to both sides of a magnetic garnet crystal directly or through transparent optical materials. However, the present invention is not limited thereto. The present invention can be applied to the optical isolator formed in multistage structure, that is, formed by further combining polarizers and Faraday rotators therewith.

Also, in the above embodiments, when optical elements are bonded, pure water is applied to each bonded surface. However, the present invention is not limited thereto. If a sufficient bonding strength is obtained without water, optical elements can be bonded to each other directly.

What is claimed is:

1. An optical device, which is formed by bonding two polarizers to both surfaces of a magnetic garnet crystal directly or through a transparent optical material without using an adhesive and which functions when light is transmitted through its bonded surface, wherein the optical device is formed with a sufficient bonding strength on either condition that
at least one or more of each linear expansion coefficient and thickness of the magnetic garnet crystal, the transparent optical material and the polarizer is controlled;
or that a bonded body, which is formed by bonding them directly or through the transparent optical material without using an adhesive, is fixed on a base.

2. A method for producing an optical device, which is formed by bonding two polarizers to both surfaces of a magnetic garnet crystal directly or through a transparent optical material without using an adhesive, wherein the formation of the optical device with a sufficient bonding strength is performed
by controlling at least one or more of each linear expansion coefficient and thickness of the magnetic garnet crystal, the transparent optical material and the polarizer;
or by forming a bonded body by bonding them directly or through the transparent optical material without using an adhesive, and then fixing the bonded body on a base.

3. An optical device, which is formed by bonding two polarizers to both surfaces of a magnetic garnet crystal through transparent optical materials without using an adhesive and which functions when light is transmitted through its bonded surface, wherein a linear expansion coefficient of the transparent optical material α2 (/° C.) takes a value between a linear expansion coefficient of the magnetic garnet crystal α1 (/° C.) and a linear expansion coefficient of the polarizer α3 (/° C.), a thickness of the transparent optical material t2 (mm) is t2≧0.02 mm, and a thickness of the polarizer t3 (mm) is 0.02 mm≦t3≦0.3 mm.

4. The optical device according to claim 3, wherein a metal oxide film is formed on a side facing the transparent optical material of the magnetic garnet crystal.

5. The optical device according to claim 4, wherein the metal oxide film formed on the magnetic garnet crystal is composed of one kind or two or more kinds of metal oxide films selected from Al₂O₃, TiO₂ and SiO₂, and the metal oxide film is laminated in single-layer or multilayer.

6. The optical device according to claim 3, wherein the magnetic garnet crystal is a bismuth-substituted iron garnet crystal.

7. The optical device according to claim 3, wherein the polarizer is a polarizing glass.

8. The optical device according to claim 3, wherein the optical device is an optical isolator formed by bonding two polarizers to both sides of the magnetic garnet crystal through the transparent optical material.

9. A method for producing an optical device by bonding two polarizers to both surfaces of a magnetic garnet crystal through transparent optical materials without using an adhesive, wherein the bonding is performed by using the transparent optical material having a linear expansion coefficient α2 (/° C.), which takes a value between a linear expansion coefficient of the magnetic garnet crystal α1 (/° C.) and a linear expansion coefficient of the polarizer α3 (/° C.), and having a thickness t2 (mm) or t2≧0.02 mm, and the polarizer having a thickness t3 (mm) of 0.02 mm≦t3≦0.3 mm.

10. The method for producing an optical device according to claim 9, wherein a bonding between the magnetic garnet crystal and the transparent optical material and/or a bonding between the transparent optical material and the polarizer are performed by subjecting each bonded surface to polishing, cleaning, hydrophilic treatment and drying process; laminating each bonded surface directly or through water; and then subjecting them to a heat treatment.

11. The method for producing an optical device according to claim 9, wherein after a metal oxide film is formed on a side facing the transparent optical material of the magnetic garnet crystal, the magnetic garnet crystal is bonded to the transparent optical material.

12. The method for producing an optical device according to claim 11, wherein the metal oxide film to be formed on the magnetic garnet crystal is composed of one kind or two or more kinds of metal oxide films selected from Al₂O₃, TiO₂ and SiO₂, and the metal oxide film is laminated in single-layer or multilayer.

13. The method for producing an optical device according to claim 9, wherein an optical isolator is produced by bonding the polarizers to both sides of the magnetic garnet crystal through the transparent optical materials.

14. An optical isolator, which is formed by fixing at least two polarizers, a magnetic garnet crystal and permanent magnets, which put the magnetic garnet crystal in the magnetic field for saturation, on a base, wherein a bonded body is formed by bonding the polarizers to the magnetic garnet crystal directly or through transparent optical materials without using an adhesive, and the bonded body, which functions when light is transmitted through its bonded surface, is fixed on the base.

15. The optical isolator according to claim 14, wherein metal oxide films are formed on each bonded surface of the magnetic garnet crystal.

16. The optical isolator according to claim 15, wherein the metal oxide films formed on the magnetic garnet crystal are composed of one kind or two or more kinds of metal oxide films selected from Al₂O₂, TiO₃ and SiO₂, and the metal oxide films are laminated in single-layer or multilayer.

17. The optical isolator according to claim 14, wherein the magnetic garnet crystal is a bismuth-substituted iron garnet crystal, and the polarizer is a polarizing glass.

18. A method for producing an optical isolator by fixing at least two polarizers, a magnetic garnet crystal and permanent magnets on a base, wherein a bonded body is formed by bonding the polarizers to the magnetic garnet crystal directly or through transparent optical materials without using an adhesive, and then the bonded body and the permanent magnets are fixed on the base by use of a bonding material.

19. The method for producing an optical isolator according to claim 18, wherein the bonding is performed after metal oxide films are formed on each bonded surface of the magnetic garnet crystal.

20. The method for producing an optical isolator according to claim 19, wherein the metal oxide films to be formed on the magnetic garnet crystal are composed of one kind or two or more kinds of metal oxide films selected from Al₂O₃, TiO₂ and SiO₂, and the metal oxide films are laminated in single-layer or multilayer.

21. The method for producing an optical device according to claim 18, wherein bondings among the polarizers, the magnetic garnet crystal and the transparent optical materials are performed by subjecting each bonded surface to cleaning, hydrophilic treatment and drying process; laminating each bonded surface directly or through water; and then subjecting them to a heat treatment

22. The method for producing an optical isolator according to claim 18, wherein when the bonded body and the permanent magnets are fixed on the base, at least one of the bonded body and the permanent magnets of the base is heated and the bonded body and the permanent magnets are fixed on the base by use of a bonding material having a melting point.

23. The method for producing an optical isolator according to claim 22, wherein when at least one of the bonded body and the permanent magnets or the flat plate is heated, Radio Frequency heating is used.
